(19) United States
(12) Patent Application Publication
(10) Pub. No.: US 2026/0120603 A1
(43) Pub. Date: Apr. 30, 2026

(54) MIRRORLESS HEAD-UP DISPLAY DEVICE

(71) Applicant: SOLUM CO., LTD., Yongin-si (KR)

(72) Inventors: Daehyun JANG, Suwon-si (KR); Yonggi KIM, Seongnam-si (KR)

(73) Assignee: SOLUM CO., LTD., Yongin-si (KR)

(21) Appl. No.: 19/432,180

(22) Filed: Dec. 24, 2025

Related U.S. Application Data
(63) Continuation of application No. PCT/KR2025/013057, filed on Aug. 27, 2025.

(30) Foreign Application Priority Data
Oct. 26, 2024 (KR) 10-2024-0148028
Oct. 26, 2024 (KR) 10-2024-0148029

(51) Int. Cl. G09G 3/06; G02B 27/01; G09G 3/20; G09G 3/34

(52) U.S. Cl. CPC G09G 3/06; G02B 27/01; G09G 3/2088; G09G 3/342; G02B 2027/014; G09G 2320/062; G09G 2360/04

(57) ABSTRACT

A mirrorless head-up display device includes a visible light generating device configured to convert electrical energy into visible light and to project the visible light toward a windshield without using a mirror, and a driver device electrically connected to provide driving signals thereto, wherein the visible light generating device is implemented as a display panel including multiple light emitting elements corresponding to the size of a screen projected on the windshield, and is divided into blocks whose optical output is individually controllable.

### CROSS-REFERENCE TO RELATED APPLICATIONS

This application is a continuation application of PCT International Patent Application No. PCT/KR2025/013057 filed on August 27, 2025, which claims priority to Korean Patent Application Nos. 10-2024-0148028 filed on October 26, 2024, and 10-2024-0148029 filed on October 26, 2024 which are all hereby incorporated by reference in their entirety.

### BACKGROUND OF THE INVENTION

The present disclosure relates generally to display devices for vehicles, and more particularly, to a mirrorless head-up display device.

Head-up displays (HUDs) have been increasingly adopted in vehicles, and user interest in such devices has been growing. A HUD is a device that provides vehicle driving information, such as driving information or navigation information, within a range that does not deviate from a driver’s forward view, that is, the driver’s primary line of sight, while a vehicle or an aircraft is traveling.

Early HUDs were developed for aircraft, particularly fighter aircraft, to provide flight information to pilots during flight. Vehicle HUDs were then developed by adapting the same principle to vehicles.

When a vehicle is driven at a speed of about 100 km/h, it may take about two seconds for a driver to move his or her line of sight from an instrument panel back to the road. During that time, the vehicle travels approximately 55 meters, which creates a constant risk of accidents. To reduce this risk, vehicle HUDs have been developed to display instrument panel information, such as speed, travel distance, and RPM, or navigation information on a front windshield in the driver’s primary line of sight, thereby enabling the driver to recognize important driving or route information without taking his or her eyes off the road.

However, in a HUD according to the related art, such as that described in Korean Patent Registration No. 10-2305956, a plurality of mirrors (for example, a folding mirror and an aspheric mirror, FIG. 9) are used to reflect light toward the windshield. A HUD implemented in this manner is suitable for providing simple information such as vehicle speed or direction, but when a variety of information needs to be displayed, optical energy output to the windshield through the mirrors is insufficient, and clear images cannot be easily provided.

### SUMMARY OF THE INVENTION

According to one aspect, a mirrorless head-up display device is provided that can output sufficient light to display various kinds of information without using a mirror.

In some embodiments, there is provided a mirrorless head-up display device including a visible light generating device configured to convert electrical energy into visible light and to output the visible light toward a windshield without reflection by a mirror, and a driver device electrically connected to the visible light generating device and configured to provide a signal to the visible light generating device.

In some embodiments, the visible light generating device is implemented as a display panel including a plurality of light emitting elements corresponding to the size of a screen displayed on the windshield.

In some embodiments, the visible light generating device can be divided into a plurality of blocks, each including a plurality of light emitting elements, and optical output can be controlled on a block basis.

In some embodiments, the visible light generating device includes a first light emitting element block configured to generate light that implements an image displayed in a first area of the screen, and a second light emitting element block configured to generate light that implements an image displayed in a second area of the screen. The first area is located more inward on the screen than the second area, and the first light emitting element block is disposed more inward than the second light emitting element block.

In further embodiments, the device includes a processor configured to provide a control signal to the driver device to control an optical output of the visible light generating device. The processor can selectively turn on or off one or more of the light emitting element blocks, so that, for example, basic vehicle information is displayed in the first area and augmented reality graphic objects, associated with external objects of the vehicle, are displayed in the second area.

In additional embodiments, the driver device includes a plurality of display driver integrated circuits (DDIs) electrically connected to at least some of the plurality of light emitting elements, and the plurality of light emitting elements are divided into a plurality of light emitting element groups based on arranged columns. Each DDI can be connected to at least two light emitting element groups that are not adjacent to each other in order to distribute driving stress and improve durability of the DDIs.

Effects obtainable according to various embodiments include at least one of the following. A high amount of light can be output to the windshield, enabling clear image expression and allowing a variety of information to be provided via the HUD. By dividing a plurality of light emitting elements into blocks and controlling the optical output on a block basis, the durability of individual light emitting elements can be managed and heat generation of the HUD can be controlled. Further, by matching light emitting element groups used with high frequency and light emitting element groups used with low frequency to individual DDIs and connecting them to single DDIs, stress applied to each DDI can be reduced and the durability of each DDI can be improved.

### BRIEF DESCRIPTION OF THE DRAWINGS

FIGS. 1 and 2 are views referred to in explaining a mirrorless head-up display device according to an embodiment of the present invention.

FIGS. 3 and 4 are views schematically illustrating a visible light generating device according to an embodiment of the present invention.

FIGS. 5 and 6 are views illustrating a screen of a HUD according to an embodiment of the present invention.

FIGS. 7 and 8 are views referred to in explaining a visible light generating device and a driver device according to an embodiment of the present invention.

FIG. 9 is a view illustrating a HUD according to the related art.

### DETAILED DESCRIPTION OF THE INVENTION

Embodiments will be described in detail below with reference to the accompanying drawings. The same or similar reference numerals refer to the same or similar components throughout the drawings, and redundant descriptions thereof may be omitted. The singular forms used herein are intended to include plural forms as well, unless the context clearly indicates otherwise. Terms such as “include” or “have” are intended to specify that one or more features, numbers, steps, operations, elements, components, or combinations thereof are present, and are not intended to preclude the possibility that one or more other features, numbers, steps, operations, elements, components, or combinations thereof may be present or added.

When a component is described as being “connected” or “coupled” to another component, it may be directly connected or coupled to the other component, or another component may be interposed therebetween. In contrast, when a component is described as being “directly connected” or “directly coupled” to another component, it is understood that there is no other component interposed therebetween.

### Overall configuration

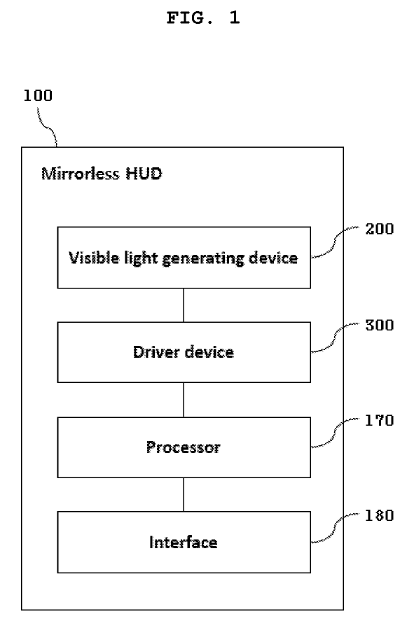

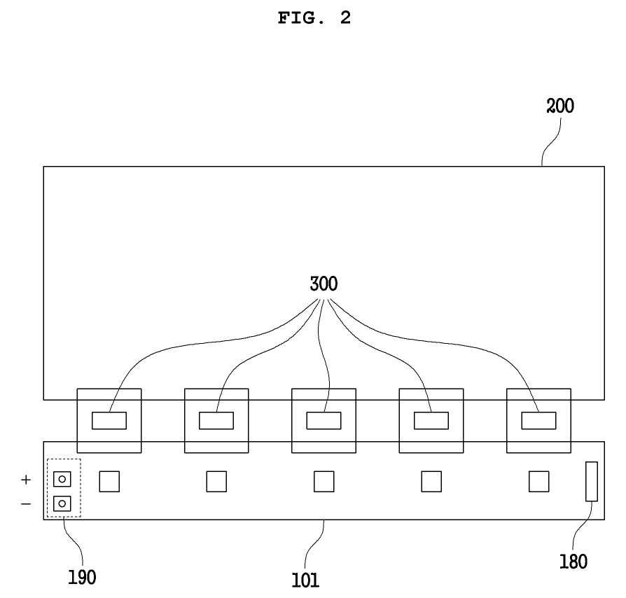

Referring to FIGS. 1 and 2, a mirrorless head-up display device 100 (hereinafter, device 100) according to an embodiment displays a screen by directly outputting visible light to a windshield of a vehicle.

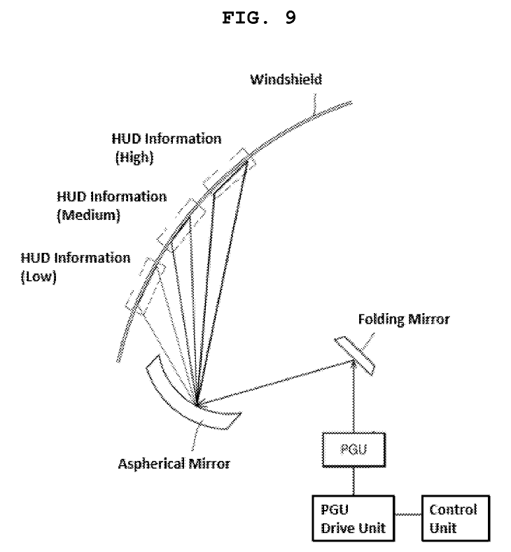

In a HUD according to the related art, as illustrated in FIG. 9, a plurality of mirrors are used to magnify an image of a small size and to form an image on the windshield, thereby visually providing information necessary for a driver. In such a HUD, the amount of visible light projected onto the windshield is insufficient, so that clear images cannot be provided to the driver, and the device tends to provide only relatively simple information, such as vehicle speed or basic turn-by-turn images.

The device 100 according to an embodiment is implemented in a mirrorless manner and may be implemented such that a display panel that forms an image has a size similar or equal to that of a screen displayed on the windshield. Accordingly, a display panel of a larger size is required, and it becomes possible to output visible light of high luminance.

However, because the device 100 outputs visible light of high luminance using a display panel including a plurality of light emitting elements, issues of heat generation and efficiency arise.

Further, to control the plurality of light emitting elements, the device 100 uses a plurality of display driver ICs (DDIs). Since only some of the light emitting elements are driven with high frequency, driving stress tends to be concentrated on specific DDIs.

The device 100 according to an embodiment can overcome these issues by dividing the plurality of light emitting elements into a plurality of blocks and controlling optical output on a block basis, and by distributing light emitting element groups among the plurality of DDIs to reduce stress on particular DDIs.

The device 100 can include a visible light generating device 200, a driver device 300, a processor 170, an interface 180, a power supply 190, and a printed circuit board (PCB) 101.

The visible light generating device 200 converts electrical energy into visible light and includes a plurality of light emitting elements for this purpose. The visible light generating device 200 outputs visible light toward the windshield without reflection by a mirror.

The visible light generating device 200 is implemented as a display panel including a plurality of light emitting elements. A size of the display panel can be equal or similar to a size of a screen displayed on the windshield. The plurality of light emitting elements can be implemented as light emitting diodes (LEDs). In some embodiments, the visible light generating device 200 can be referred to as a backlight unit.

The driver device 300 is electrically connected to the visible light generating device 200 and provides signals thereto. The visible light generating device 200 outputs visible light based on the signals provided from the driver device 300.

The processor 170 can be implemented using at least one of an application specific integrated circuit, a digital signal processor, a digital signal processing device, a programmable logic device, a field programmable gate array, a processor, a controller, a microcontroller, a microprocessor, or other electronic units for performing functions.

The processor 170 is electrically connected to the driver device 300, the interface 180, the power supply 190, and the PCB 101, and provides control signals to the driver device 300 to control an optical output of the visible light generating device 200.

The interface 180 exchanges signals in a wired or wireless manner with at least one electronic device provided in the vehicle. The interface 180 may include at least one communication module, terminal, pin, cable, port, circuit, element, or device.

The interface 180 can receive information from other devices in the vehicle, and the processor 170 controls the visible light generating device 200 based on the received information.

For example, the interface 180 can receive information on external objects of the vehicle from an object detection device. External objects of the vehicle may include other vehicles, pedestrians, lanes, lane markers, street lights, and roadside trees, which are detectable by one or more sensors of the vehicle.

In addition, the interface 180 can receive, from a sensing unit of the vehicle, vehicle posture information, vehicle motion information, yaw, roll, and pitch information of the vehicle, collision information, vehicle direction and angle information, vehicle speed and acceleration information, vehicle inclination information, forward and reverse information, battery and fuel information, tire information, lamp information, interior temperature and humidity information, steering wheel rotation angle, exterior brightness, pressure applied to an accelerator pedal, pressure applied to a brake pedal, and position information of the vehicle.

The interface 180 can also receive, from a navigation system of the vehicle, destination information, direction change information, position information, remaining distance information, traffic condition information, speed camera information, traffic sign information, and traffic signal information.

The power supply 190 supplies power to the device 100. The power supply 190 receives power from a power source such as a battery included in the vehicle and supplies power to each unit of the device 100.

The PCB 101 is electrically connected to the visible light generating device 200, the driver device 300, the processor 170, the interface 180, and the power supply 190.

Block structure of visible light generating device

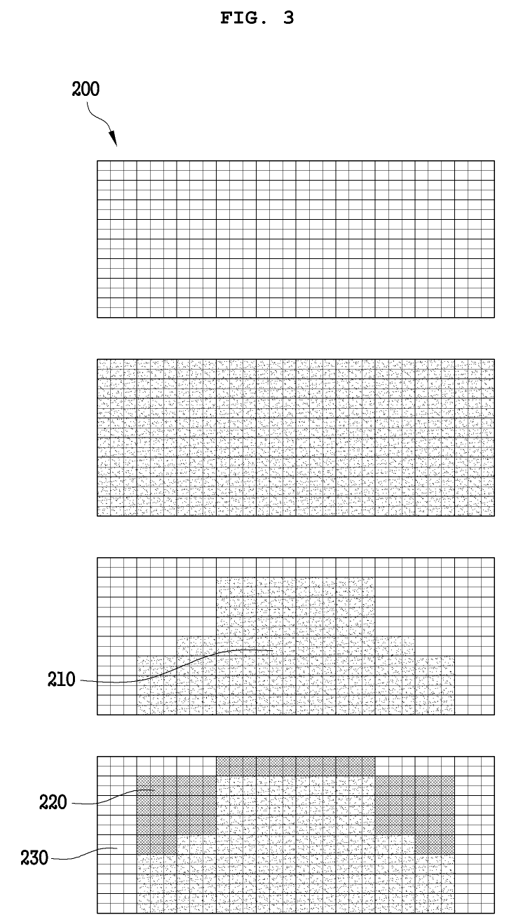

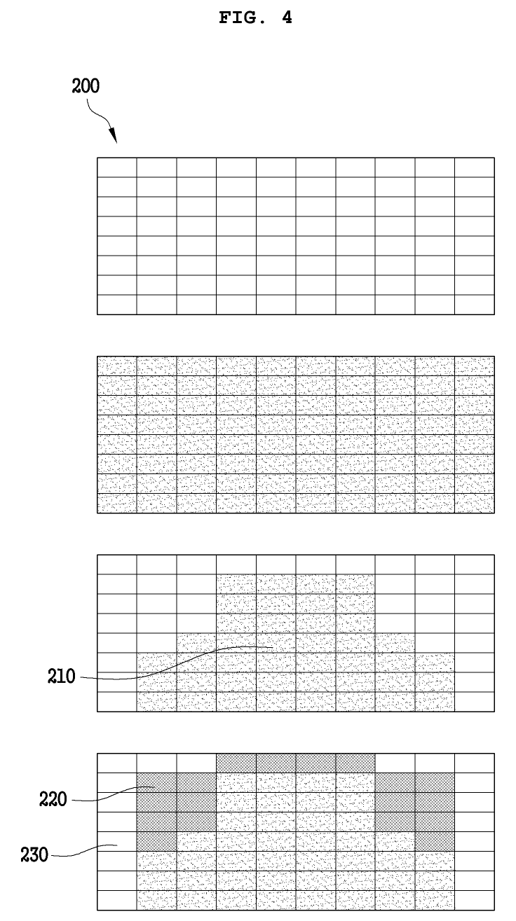

Referring now to FIGS. 3 and 4, the visible light generating device 200 is divided into a plurality of blocks 210, 220, and 230, and its optical output is controlled on a block basis.

Each of the blocks 210, 220, and 230 is composed of a plurality of cells, and at least one light emitting element is disposed in each cell. FIG. 3 illustrates an example in which a plurality of cells and the blocks 210, 220, and 230 are shown, and FIG. 4 illustrates the visible light generating device 200 represented only by the blocks 210, 220, and 230.

The visible light generating device 200 includes a first light emitting element block 210, a second light emitting element block 220, and a third light emitting element block 230.

The first light emitting element block 210 is implemented as a plurality of blocks, each composed of a plurality of cells, and can be described as a block having the highest usage frequency among the light emitting elements. The first light emitting element block 210 has a higher usage frequency than the second light emitting element block 220 and the third light emitting element block 230.

The first light emitting element block 210 generates light that implements an image displayed in a first area of the screen projected onto the windshield. Graphic images corresponding to basic information provided from the vehicle are displayed in the first area. The basic information may be information generated by the sensing unit of the vehicle and received via the interface 180 or information generated by the navigation system of the vehicle and received via the interface 180.

The second light emitting element block 220 is implemented as a plurality of blocks, each composed of a plurality of cells. The second light emitting element block 220 has a lower usage frequency than the first light emitting element block 210 but a higher usage frequency than the third light emitting element block 230.

The second light emitting element block 220 generates light that implements an image displayed in a second area of the screen projected onto the windshield. Graphic objects associated with external objects of the vehicle are displayed in the second area. Information on the external objects of the vehicle is generated by the object detection device and received via the interface 180. The information may include presence or absence of external objects, relative positions of external objects, and distances between the vehicle and the external objects.

The second area may be a wider area than the first area and may include the first area.

The third light emitting element block 230 is implemented as a plurality of blocks, each composed of a plurality of cells, and can be described as a block having the lowest usage frequency among the light emitting elements. The third light emitting element block 230 has a lower usage frequency than the first and second light emitting element blocks 210 and 220.

The third light emitting element block 230 generates light that implements an image displayed in a third area of the screen projected onto the windshield. Graphic objects related to a foreground, such as mountains, sky, sea, rice fields, and farms, that are not directly related to driving of the vehicle are displayed in the third area. The third area may correspond to an area obtained by excluding the second area from the entire screen.

In the screen projected onto the windshield, the first area is located more inward on the screen than the second area. In the display panel 200, the first light emitting element block 210 is disposed more inward than the second light emitting element block 220, and the second light emitting element block 220 can be disposed to surround the first light emitting element block 210.

Similarly, the second area is located more inward on the screen than the third area. In the display panel 200, the second light emitting element block 220 is disposed more inward than the third light emitting element block 230, and the third light emitting element block 230 can be disposed to surround the second light emitting element block 220.

### Control of blocks and HUD screen examples

The processor 170 provides a control signal to the driver device 300 so that the second light emitting element block 220 maintains an off state while the first light emitting element block 210 is in an on state. In this case, the first area displays basic information provided from the vehicle based on light generated by the first light emitting element block 210.

Conversely, the processor 170 can provide a control signal so that the second light emitting element block 220 maintains an on state while the first light emitting element block 210 is in an on state. In this case, the second area displays graphic objects associated with external objects of the vehicle based on light generated by the second light emitting element block 220. The graphic objects can implement augmented reality by being matched with the external objects of the vehicle.

The processor 170 can receive information on external objects of the vehicle via the interface 180 and can display augmented reality objects associated with the external objects by matching the augmented reality objects with the external objects.

An on state of a light emitting element block refers to a state in which current flows into the light emitting elements included in the block and electrical energy is converted into visible light so that visible light is output, and an off state refers to a state in which current does not flow into the light emitting elements included in the block and visible light is not output.

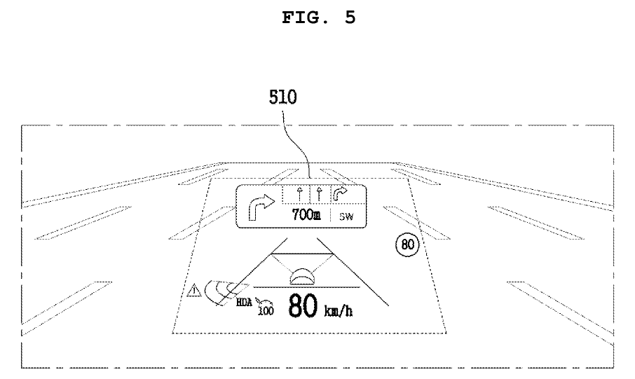

Referring to FIG. 5, when the first light emitting element block 210 is in an on state and the second light emitting element block 220 is maintained in an off state, the processor 170 controls the driver device 300 so that basic information provided from the vehicle is displayed in a first area 510. The driver device 300 transmits a control signal so that the first light emitting element block 210 in the visible light generating device 200 is turned on.

The processor 170 may display, in the first area 510, at least one of sensing information received from the sensing unit of the vehicle and navigation information received from the navigation system. Examples of such information include speed information, turn-by-turn information, traffic sign information, and speed limit information.

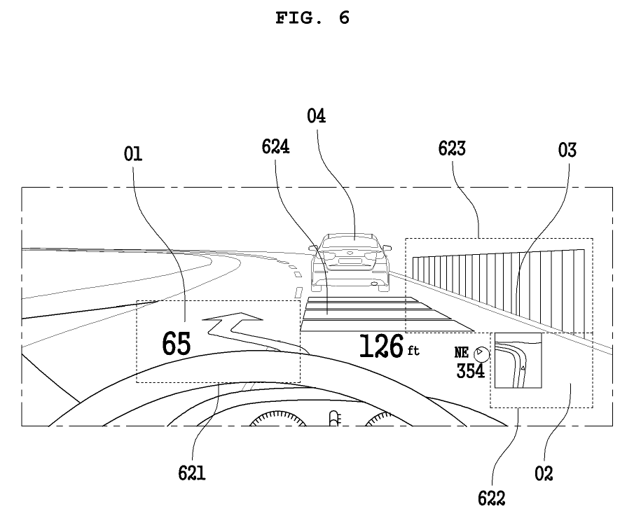

Referring to FIG. 6, when the first light emitting element block 210 is in an on state and the second light emitting element block 220 is also maintained in an on state, the processor 170 controls the driver device 300 so that graphic objects associated with external objects O1, O2, O3, and O4 of the vehicle are displayed in second areas 621, 622, 623, and 624. The driver device 300 transmits a control signal so that the second light emitting element block 220 in the visible light generating device 200 is turned on.

The graphic objects can implement augmented reality by being matched with the external objects O1, O2, O3, and O4.

For example, the processor 170 may display an arrow indicating a lane change instruction matched with an adjacent lane O1. The processor 170 may display an image indicating a position of the vehicle on a road matched with a road O2. The processor 170 may display a virtual wall image matched with a lane marker O3. The processor 170 may display an image indicating a distance to a preceding vehicle matched with the preceding vehicle as an external object.

The processor 170 can control the driver device 300 based on a navigation mode. When the navigation is set to a first mode, such as a general navigation mode, according to a user input, the processor 170 may control the driver device 300 so that basic vehicle information is displayed in the first area, and in that case only the first light emitting element block 210 is turned on and driven under control of the driver device 300. When the navigation is set to a second mode, such as an augmented reality navigation mode, the processor 170 may control the driver device 300 so that augmented reality graphic objects are displayed in the second area, and both the first and second light emitting element blocks 210 and 220 are turned on and driven under control of the driver device 300.

### Driver device and DDI connection structure

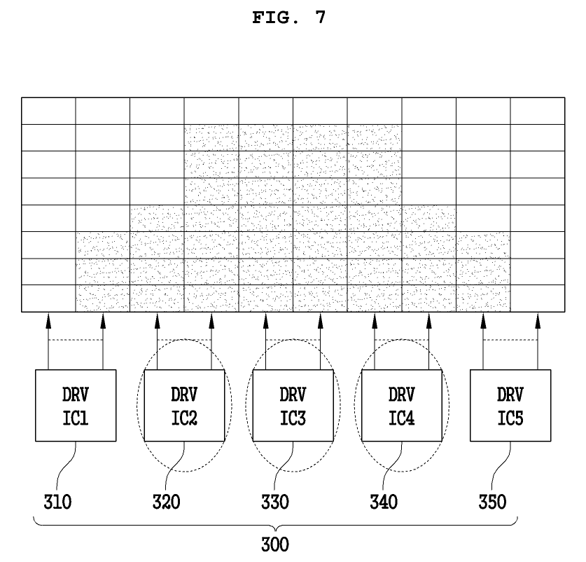

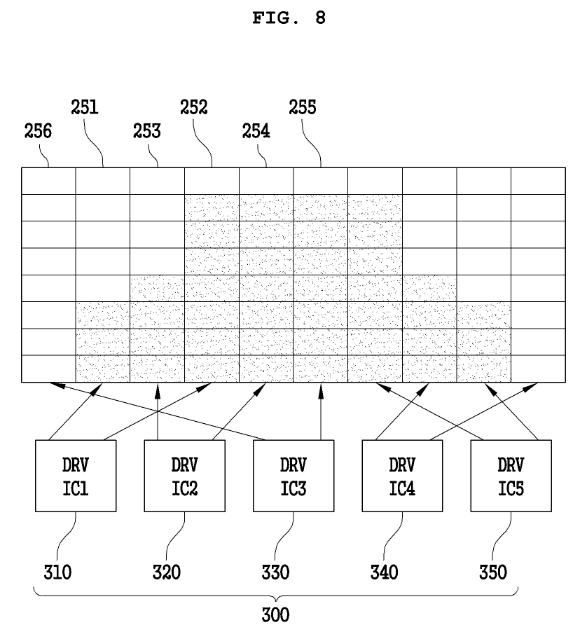

Referring to FIGS. 7 and 8, the driver device 300 includes a plurality of DDIs 310, 320, 330, 340, and 350. The plurality of DDIs are electrically connected to at least some of the plurality of light emitting elements and control driving of the light emitting elements.

The plurality of light emitting elements included in the visible light generating device or light output device can be divided into a plurality of light emitting element groups based on arranged columns. The plurality of DDIs 310, 320, 330, 340, and 350 are electrically connected to at least some of the plurality of light emitting element groups. Each of the DDIs can be electrically connected to at least two light emitting element groups.

As illustrated in FIG. 7, when the plurality of DDIs 310, 320, 330, 340, and 350 are sequentially connected such that each DDI drives two adjacent light emitting element groups, excessive stress can be applied to certain DDIs, for example the second, third, and fourth DDIs 320, 330, and 340, because the first light emitting element block 210 is driven more frequently. As a result, damage may occur earlier in the second to fourth DDIs than in the first DDI 310 or the fifth DDI 350.

To alleviate stress applied to particular DDIs, the plurality of DDIs and light emitting element groups can be connected in a matched manner such that each DDI drives two or more light emitting element groups that are not adjacent to one another.

Referring to FIG. 8, the driver device 300 includes, for example, the first DDI 310, the second DDI 320, and the third DDI 330.

The first DDI 310 is electrically connected to a first light emitting element group 251 among the plurality of light emitting elements and a second light emitting element group 252 that is not adjacent to the first light emitting element group 251.

The second DDI 320 is electrically connected to a third light emitting element group 253 disposed between the first light emitting element group 251 and the second light emitting element group 252 and a fourth light emitting element group 254 that is not adjacent to the third light emitting element group 253.

Each of the DDIs 310, 320, 330, 340, and 350 can be electrically connected to a light emitting element group that generates visible light implementing at least a portion of an image displayed in the first area of the screen and to a light emitting element group that generates visible light implementing at least a portion of an image displayed in the second area of the screen. For example, the third DDI 330 may be electrically connected to an a-th light emitting element group 255 that generates visible light implementing at least a portion of an image displayed in the first area of the screen and a b-th light emitting element group that generates visible light implementing at least a portion of an image displayed in the second area of the screen.

By such electrical connections, driving stress applied to each of the plurality of DDIs can be made relatively uniform, thereby improving durability of the DDIs.

### Implementation

The above-described embodiments can be implemented as computer-readable code recorded on a computer-readable medium. The computer-readable medium may be any recording device on which data readable by a computer system can be stored, including, for example, a hard disk drive, a solid state disk, a silicon disk drive, a read-only memory, a random access memory, a CD-ROM, a magnetic tape, a floppy disk, or an optical data storage device. The computer may include a processor or controller.

The foregoing detailed description is not intended to be limiting in all respects but rather illustrative. The scope of the present invention should be determined by reasonable interpretation of the appended claims, and all modifications within the equivalent scope of the present invention are intended to be included therein.

What is claimed is:

1. A mirrorless head-up display device comprising:
a visible light generating device configured to convert electrical energy into visible light and to output the visible light toward a windshield without reflection by a mirror, and
a driver device electrically connected to the visible light generating device and configured to provide a signal to the visible light generating device.

2. The mirrorless head-up display device of claim 1, wherein the visible light generating device is implemented as a display panel including a plurality of light emitting elements corresponding to a size of a screen displayed on the windshield.

3. The mirrorless head-up display device of claim 2, wherein the visible light generating device is divided into a plurality of blocks each including a plurality of the light emitting elements, and an optical output of the visible light generating device is controlled on a block basis.

4. The mirrorless head-up display device of claim 3, wherein the visible light generating device comprises:
a first light emitting element block configured to generate light that implements an image displayed in a first area of the screen, and
a second light emitting element block configured to generate light that implements an image displayed in a second area of the screen.

5. The mirrorless head-up display device of claim 4, wherein the first area is located more inward on the screen than the second area, and the first light emitting element block is disposed more inward than the second light emitting element block.

6. The mirrorless head-up display device of claim 4, further comprising a processor configured to control an optical output of the visible light generating device by providing a control signal to the driver device.

7. The mirrorless head-up display device of claim 6, wherein the processor is configured to provide the control signal so that the second light emitting element block maintains an off state while the first light emitting element block is in an on state.

8. The mirrorless head-up display device of claim 7, wherein the first area is configured to display basic information provided from a vehicle based on light generated by the first light emitting element block.

9. The mirrorless head-up display device of claim 4, wherein the processor is configured to provide the control signal so that the second light emitting element block maintains an on state while the first light emitting element block is in an on state.

10. The mirrorless head-up display device of claim 2, wherein the driver device comprises a plurality of display driver integrated circuits electrically connected to at least some of the plurality of light emitting elements.

11. The mirrorless head-up display device of claim 10, wherein the plurality of light emitting elements are divided into a plurality of light emitting element groups based on arranged columns, and the plurality of display driver integrated circuits are electrically connected to at least some of the plurality of light emitting element groups.

12. The mirrorless head-up display device of claim 11, wherein each of the plurality of display driver integrated circuits is electrically connected to at least two of the light emitting element groups.

13. The mirrorless head-up display device of claim 12, wherein the driver device comprises a first display driver integrated circuit electrically connected to a first light emitting element group among the plurality of light emitting elements and to a second light emitting element group that is not adjacent to the first light emitting element group.

14. The mirrorless head-up display device of claim 13, wherein the driver device further comprises a second display driver integrated circuit electrically connected to a third light emitting element group disposed between the first light emitting element group and the second light emitting element group and to a fourth light emitting element group that is not adjacent to the third light emitting element group.

15. The mirrorless head-up display device of claim 13, wherein the driver device further comprises a third display driver integrated circuit electrically connected to an a-th light emitting element group configured to generate visible light implementing at least a portion of an image displayed in a first area of the screen and to a b-th light emitting element group configured to generate visible light implementing at least a portion of an image displayed in a second area of the screen.
